(19) United States
(12) Patent Application Publication
(10) Pub. No.: US 2014/0197143 A1
(43) Pub. Date: Jul. 17, 2014

(54) MOVEMENT METHOD FOR RE-MELTING CRACKS

(71) Applicant: SIEMENS AKTIENGESELLSCHAFT, Munchen (DE)

(72) Inventors: Bernd BURBAUM, Falkensee (DE); Torsten JOKISCH, Neuenhagen bei Berlin (DE)

(73) Assignee: SIEMENS AKTIENGESELLSCHAFT, Munchen (DE)

(21) Appl. No.: 14/150,274

(22) Filed: Jan. 8, 2014

(30) Foreign Application Priority Data
Jan. 11, 2013 (EP) 13150981

(51) Int. Cl. B23K 26/00; B23K 26/24

(52) U.S. Cl. CPC B23K 26/0081; B23K 26/24
USPC 219/121.64; 219/121.66

(57) ABSTRACT

Re-melting the material of a component transversely to the propagation direction of a crack in the component, providing a welding beam on the component and moving the welding beam at least transversely over the crack for re-melting the material, and more material is re-melted and increasing the strength of the re-melted crack.

### FIELD OF THE INVENTION

The invention relates to a method of moving a welding beam for re-melting cracks in a weldable component.

### TECHNICAL BACKGROUND

In the case of components which are under load when in service and which are made of nickel-based superalloys that are solidified in polycrystalline form, continuous cracks in the component, particularly at its surface and below the surface are preferably repaired by re-melting, using laser radiation in order to maintain the mechanical properties of the components to be repaired in the region of the base material.

On account of the susceptibility of nickel-based superalloys to hot cracking when repaired by re-melting, particularly at its surface and below the surface, improvement is necessary.

### SUMMARY OF THE INVENTION

It is therefore an object of the invention to solve the abovementioned problem.

As the course of a crack below the surface is generally unknown, it is proposed that the direction of movement of a welding beam or laser radiation runs transversely to the direction of propagation of the crack. Experiments have shown that re-melting transversely to the direction of propagation of the crack leads to higher quality re-melting results, with respect to crack closure and surface quality, when compared to re-melting in the crack propagation direction. When compared to re-melting in the crack propagation direction, for the purpose of crack closure, more melt is melted, so that the melt is distributed more homogeneously for closing the crack. If re-melting is carried out only in the direction of propagation of the crack, less material is re-melted for closing the crack and the crack can open laterally next to the molten bath.

### BRIEF DESCRIPTION OF THE DRAWINGS

FIGS. 1-4 show patterns of movement according to the invention,

FIG. 5 shows a list of superalloys.

### DESCRIPTION OF EMBODIMENTS

The figures and the description merely illustrate exemplary embodiments of the invention.

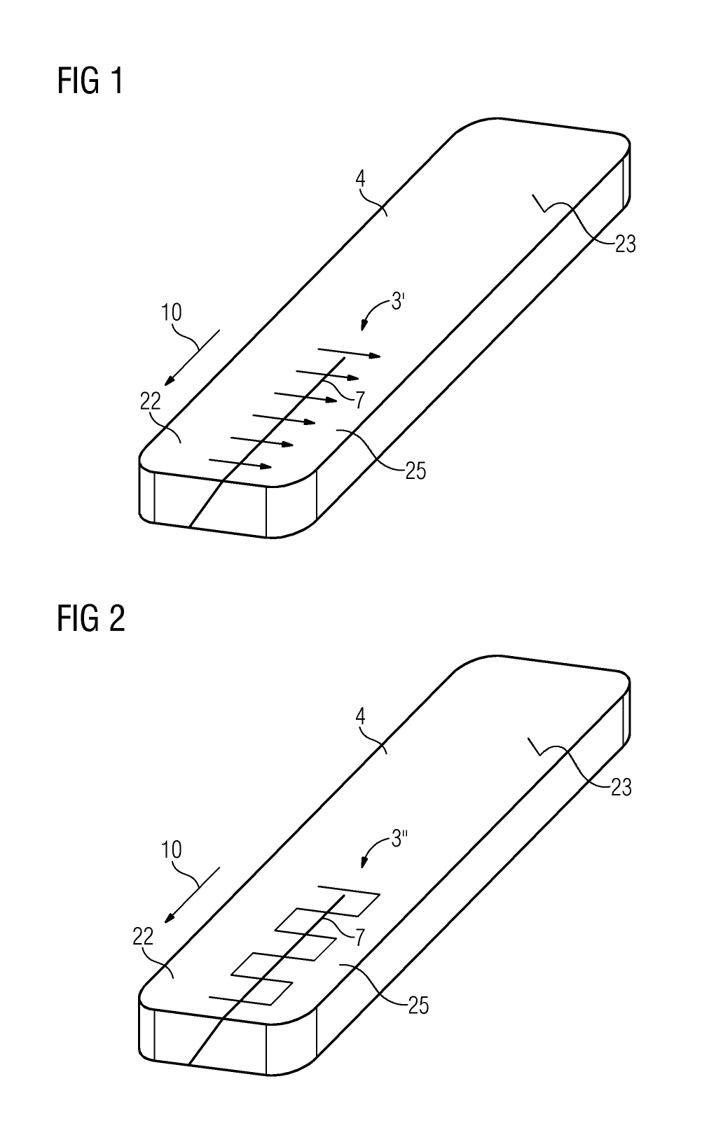

FIG. 1 shows a first exemplary embodiment of the movement path of a welding beam 13 which beam is delivered as shown in FIG. 4. A substrate of a component 4 has, in a surface 23, a crack 7, having a direction of propagation 10, which is to be re-melted. Preferably, no material is deposited.

A pattern of movement of the welding beam 13 according to the invention provides that the welding beam 13 moves over the crack 7, at least locally, transverse to or perpendicular to the direction of propagation 10.

In this case, the pattern of movement 3′ is such that the welding beam proceeds from one side 22 of the crack 7 to the other side 25 of the crack 7 and is then switched off or it is then moved such that it does not re-melt the component 4 and is displaced in the direction of propagation 10 of the crack 7, where the beam preferably is also again displaced transversely to the direction of propagation 10 and is then once again moved, transversely to the crack 7, toward the first side 22 of the crack 7.

The direction of movement is indicated and represented in the figures by means of arrows. The welding beam 13 is switched on only along those lines where the arrows are.

The individual re-melted welding tracks transverse to the direction of propagation 10 may preferably overlap (not shown).

FIG. 2 shows a different pattern of movement 3″ in which movement over the crack 7 follows a zigzag pattern or a meandering shape in the direction of propagation 10 of the crack 7.

In so doing, the separation between the welding tracks in the direction of propagation 10 is preferably chosen such that they overlap.

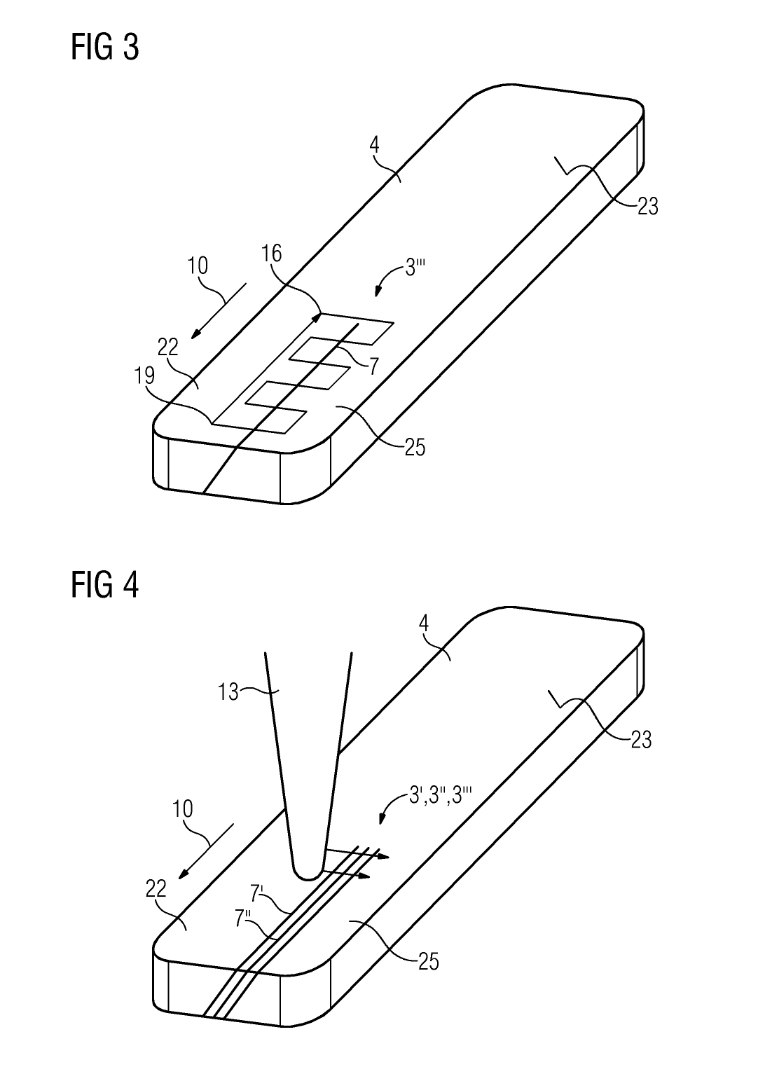

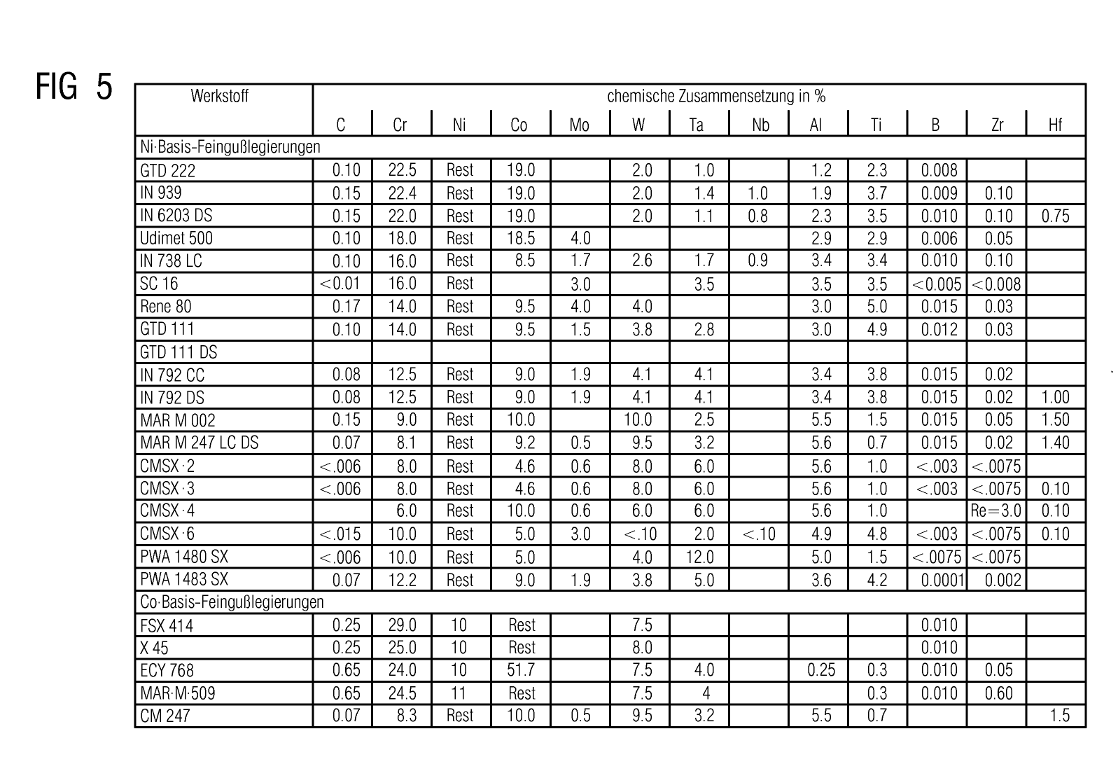

FIG. 3 shows a modification 3″′ of the exemplary embodiment of FIG. 4, 2 or 1, in which from the end point 19 of the welding, i.e. after fully traversing the crack 7 for the purpose of re-melting, the welding beam, which is once again switched on, runs back to the starting point 16 of the re-melting so as to even out any bumps that are present.

FIG. 4 shows a further exemplary embodiment 3′, 3″, 3″′ of the invention, in which multiple cracks 7′, 7″, . . . are re-melted. Such cracks 7′, 7″, . . . in particular cannot be re-melted or covered by parallel movement along the crack propagation direction 10. Instead, the multiple cracks are therefore all crossed in each sweep or traversal by the welding beam over the cracks passed over by the then traversing welding beam

The foregoing method is particularly suited to laser welding using laser beams 13.

What is claimed is:

1. A method for re-melting at least one crack in a re-meltable metal component by means of a welding beam, wherein the crack has a longitudinal direction of propagation;
at least locally over the component re-meltable metal, the method comprising moving the welding beam transversely to a direction of propagation of the at least one crack in the component.

2. The method as claimed in claim 1, further comprising: moving the welding beam over the component, both parallel to and transversely to the direction of propagation of the crack.

3. The method as claimed in claim 1, moving the welding beam only transversely to or only perpendicular to the direction of propagation of the crack or a plurality of the cracks.

4. The method as claimed in claim 3, wherein the welding beam begins welding from one side of the crack and produces welds at locations along the direction of propagation of the crack.

5. The method as claimed in claim 3, further comprising, at the end of the complete re-welding of the crack, moving the welding beam back to a starting point of the welding.

6. The method as claimed in claim 1, wherein there are a plurality of the cracks running close to one another in the re-meltable metal, and the re-melting of the plurality of the cracks is performed in one continuous process.

7. The method as claimed in claim 1, wherein the melting uses a laser beam applied to the crack.

8. The method as claimed in claim 1, wherein no material is deposited on a surface of the component at the crack for the step of welding.

9. The method as claimed in claim 1, wherein the component has a polycrystalline substrate.

10. The method according to claim 2, further comprising moving the welding beam in a meandering manner over the crack and in the direction of propagation of the crack when not passing over the crack.

11. The method according to claim 5, further comprising moving the welding beam back to a starting point of the welding and at a distance from the crack and generally in a direction of propagation of the crack.

12. The method of claim 1, wherein the welding beam is operated so that during and/or after moving the beam across the crack, the beam does not cause re-melting of a weld or melting of the component.

13. The method of claim 12, wherein to prevent re-melting, as the welding beam crosses the crack, the welding beam is switched off.

14. The method of claim 12, wherein to prevent re-melting, as the welding beam crosses the crack, the welding beam is moved over the component such that the beam does not re-melt the component.

15. The method of claim 14, wherein the moving of the beam is displacement thereof generally along the direction of propagation at the crack, and spaced away from the crack.
